(19) United States
(12) Patent Application Publication
(10) Pub. No.: US 2025/0004218 A1
(43) Pub. Date: Jan. 2, 2025

(54) OPTICAL DEVICE INCLUDING A FIBER ALIGNMENT STRUCTURE

(71) Applicant: PSIQUANTUM CORP., Palo Alto, CA (US)

(72) Inventors: Eric DUDLEY, Sacramento, CA (US); Jin YAO, San Diego, CA (US); Nathan A. NUTTALL, Castaic, CA (US)

(21) Appl. No.: 18/692,978

(22) PCT Filed: Sep. 19, 2022
(86) PCT No.: PCT/US2022/043969

§ 371 Date: Mar. 23, 2023

Related U.S. Application Data
(60) Provisional application No. 63/245,266, filed on Sep. 17, 2021.

(51) Int. Cl. G02B 6/42; G02B 6/30

(52) U.S. Cl. CPC G02B 6/423; G02B 6/30; G02B 6/4239

(57) ABSTRACT

An optical device includes an optical fiber and an optical die connected to the optical fiber. The optical fiber includes a core layer, a cladding layer formed on the core layer, and a first portion of a fiber alignment structure formed on the cladding layer. The optical die includes a die main body, an optical waveguide located in the die main body, and a second portion of the fiber alignment structure formed on the die main body and mated to the first portion of the fiber alignment structure so as to align the core layer of the optical fiber with the optical waveguide.

### TECHNICAL FIELD

An embodiment of the present disclosure is directed to an optical device and more particularly, to an optical device including a fiber alignment structure.

### BACKGROUND

There are presently a multitude of input/output (I/O) solutions used to connect an optical fiber to an optical die (e.g., photonic chip, photonic die, optical chip, etc.). V-grooves or fiber array units attached to an optical die with adhesives are commonly used techniques in industry. These techniques may rely on either the stability of the epoxy attachment under an active alignment process, or on the manufacturing tolerances of the fiber core position and v-groove manufacture under a passive alignment process.

### SUMMARY

An aspect of the present disclosure is directed to an optical device that may include an optical fiber including a core layer, a cladding layer formed on the core layer, and a first portion of a fiber alignment structure formed on an end face the cladding layer, and an optical die connected to the optical fiber, including a die main body, an optical waveguide located in the die main body, and a second portion of the fiber alignment structure formed on the die main body and mated to the first portion of the fiber alignment structure so as to align the core layer of the optical fiber with the optical waveguide.

Another aspect of the present disclosure is directed to a method of forming an optical device. The method may include forming a first portion of a fiber alignment structure on an end face of a cladding layer of an optical fiber, forming a second portion of the fiber alignment structure on a die main body of an optical die, and mating the first portion of the fiber alignment structure to the second portion of the fiber alignment structure so as to align a core layer in the optical fiber with an optical waveguide in the optical die.

Another aspect of the present disclosure is directed to an optical fiber, comprising a core layer, a cladding layer formed on the core layer, and a first portion of a fiber alignment structure comprising an alignment projection or an alignment hole formed on an end face of the cladding layer. The first portion of the fiber alignment structure is configured to be mated to a portion of the fiber alignment structure located on an optical die so as to align the core layer of the optical fiber with an optical waveguide of the optical die.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the Figures.

FIG. 1A is an exploded perspective view of an optical device 100 according to one or more embodiments.

FIG. 1B is an exploded perspective view of an optical device 150 according to one or more embodiments.

FIG. 2A is a vertical cross-sectional view of the optical device 100 according to one or more embodiments.

FIG. 2B is a perspective view and FIG. 2C is a perspective cut away view of the optical device 150 according to one or more embodiments.

FIG. 3 is a perspective view of an optical device 300 according to one or more embodiments.

FIG. 4 is a perspective view of an optical device 400 according to one or more embodiments.

FIG. 5 is a perspective view of an optical device 500 according to one or more embodiments.

FIG. 6 is a perspective view of an optical device 600 according to one or more embodiments.

FIG. 7 illustrates steps in a method of making the optical device 100 according to one or more embodiments.

FIG. 8 is flow chart of a method of forming an optical device according to one or more embodiments.

FIG. 9 is a perspective view of an optical device 900 according to one or more embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

One or more embodiments of the present disclosure may be directed to an optical device including a fiber alignment structure. The embodiments of the present disclosure may provide a scalable, high-efficiency die-to-fiber coupler (e.g., chip-to-fiber coupler) having improved optical alignment, high-density fiber attachment, and a scalable assembly. In particular, the embodiments of the present disclosure may provide a high-density, low-loss die-to-fiber (e.g., fiber-to-die) accurate assembly mechanism with cryogenic temperature stability.

Prior art optical input/output (I/O) packaging techniques may be unable to precisely align an optical fiber at an optimal position on an optical die. This may be due to several factors, including core position relative to fiber diameter, epoxy shrinkage and aging, backlash and stability issues on alignment tooling, and mechanical stress during the packing process. The optical device of the embodiments of the present disclosure, on the other hand, may provide an extremely high-efficiency coupler between an optical fiber and an optical die. The optical device may provide an I/O solution capable of achieving an extremely tight alignment tolerance between an attached optical fiber and an edge of the optical die.

In one or more embodiments, an optical device may include a fiber alignment structure for aligning an optical fiber or multiple fibers in the form of an array with an optical die. The fiber alignment structure may include a first portion of a fiber alignment structure that may be fabricated onto an end of the optical fiber (e.g., an end that has been cleaved by laser or otherwise). As used herein, an “end” or an “end face” of the optical fiber refers to an edge surface or face of the optical fiber that is not parallel to (e.g., is perpendicular to) the axis of the optical fiber. Alternatively, the first portion of the fiber alignment structure may be etched into the end of the optical fiber by forming a mask onto the fiber end surface and performing an etching process (e.g., wet and/or dry etching process). The fiber alignment structure may also include a second portion formed on an optical die. The first portion of the fiber alignment structure may be mated with the second portion of the fiber alignment structure so as to precisely align a core of the optical fiber with an optical waveguide of the optical die.

In one or more embodiments, the first portion of the fiber alignment structure may include an alignment projection (e.g., male structure) and the second portion of the fiber alignment structure may include an alignment hole (e.g., female structure). In one or more embodiments, the second portion of the fiber alignment structure may include an alignment projection (e.g., male structure) and the first portion of the fiber alignment structure may include an alignment hole (e.g., female structure). The first portion of the fiber alignment structure may be mated to the second portion of the fiber alignment structure by inserting the alignment projection into the alignment hole.

The mating of the first portion of the fiber alignment structure and the second portion of the fiber alignment structure may be used to passively align an optical core (e.g., core layer) in the optical fiber to a matching optical waveguide on the optical die with a very high precision. The waveguide may have a smaller width (e.g., diameter) than that of the core layer. Thus, the fiber alignment structure facilitates a more precise optical alignment between two elements having a different diameter. The precision of the alignment may be limited only by an accuracy of the fabrication process or etching process on the end of the optical fiber, and the matching process on the optical die. This alignment process can also be used to passively align polarization maintaining (PM) fibers to a very high precision by printing or etching the structure relative to the PM core axis. Once inserted and aligned, the optical fiber can be attached to the optical die using any suitable method, such as using epoxy, solder, glass seal or other methods within a structure or groove created on the die or otherwise.

The fiber alignment structure may include, for example, a die coupler having an undercut area (e.g., in the alignment hole) that can provide a reference feature that may be relied on as a point of reference in performing an alignment of the optical fiber to the optical die. This undercut area can be formed in many ways including, for example, a crystallographic wet etch process or a deep reacting ion etch (DRIE) process, etc. However, it should be noted that the undercut area is optional and that there are embodiments of the present disclosure that may provide the same type of alignment without an undercut area on the optical die. A design for aligning to a crystallographic wet etch may vary from those using DRIE or other etch processes, since an accurate and consistent wet etch feature can be used to accurately register the position of the optical fiber without having to register to other etch locations.

In one or more embodiments, the alignment projection may include a printed or etched alignment structure on an end face of the optical fiber that may be coned or drafted in order to facilitate an easy insertion of the alignment projection into a mated alignment, and may provide for a more accurate alignment as the optical fiber is inserted closer to the optical die coupling waveguide. Further, the alignment projection may include a recessed area that may help to keep the deposited (e.g., 3D printed) material out of an optical beam being transmitted by the optical fiber, thus reducing the optical insertion loss. The alignment structure can be designed to have 99% or better insertion loss, plus only down to 0.01 dB excess loss with alignment, to conventional fibers SMF28 or PM1550, over a wide bandwidth thanks to the nature of edge coupling. Other fiber types will achieve similarly improved performance from the improvement in alignment accuracy.

It should be noted that there may be alternate embodiments that are not described in detail in the present disclosure. For example, there may be types and configurations of docking receptacles on an end face (e.g., facet) of an optical die other than those described herein. The embodiments described herein are illustrative embodiments that may showcase examples of docking receptacles to the optical waveguide, but this disclosure is not limited to these illustrative embodiments. The present disclosure may include alternative designs and configurations that may align the optical waveguide using deposited (e.g., 3D printed) or etched features on the end face of an optical fiber.

In particular, the embodiments of the present disclosure may include an optical device with the fiber alignment structure together with another mechanism for connecting an optical fiber to an optical die. For example, in addition to the fiber alignment structure, the optical device may include a V-groove or fiber array unit attached to the optical die with an adhesive, or other connecting mechanisms.

The embodiments of the present disclosure may provide advantageous new features. For example, the embodiments may both increase the performance and decrease the cost and complexity of an edge coupler assembly (e.g., fiber alignment structure). 3D printed or etched fiber features can have extremely precise alignment to the edge coupler facet due to excellent vision systems employed during the 3D printing process and the extremely small feature size achievable using two-photon polymerization. While 3D printing is described herein as an example of a material deposition process, any other suitable material deposition process may be used instead. The process to create deposited or etched features can be very accurately aligned not only to a core position in the optical fiber, but also to a PM axis of the optical fiber, making quick passive alignment of PM fiber or SM fiber independent of fiber core offset, V-groove tolerance, fiber diameter tolerance, etc.

The embodiments of the present disclosure may provide the advantage of allowing for a high-density arrangement of optical fibers (e.g., as dense as the bare fiber). The embodiments of the present disclosure may also provide a low-loss, fiber-to-die coupling (e.g., fiber-to-die coupling), an accurate assembly, an easy rotational alignment, and temperature stability that is less dependent on built-in stresses within epoxy.

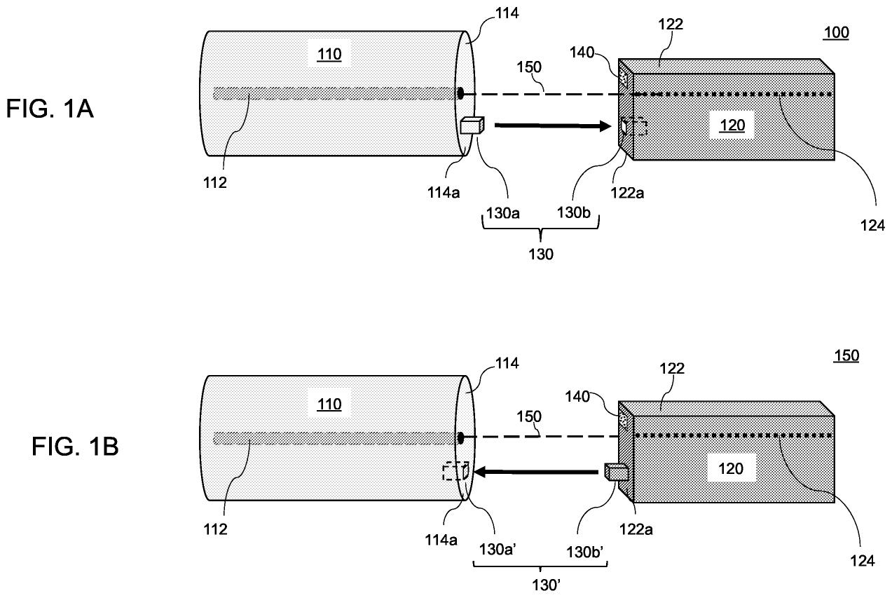

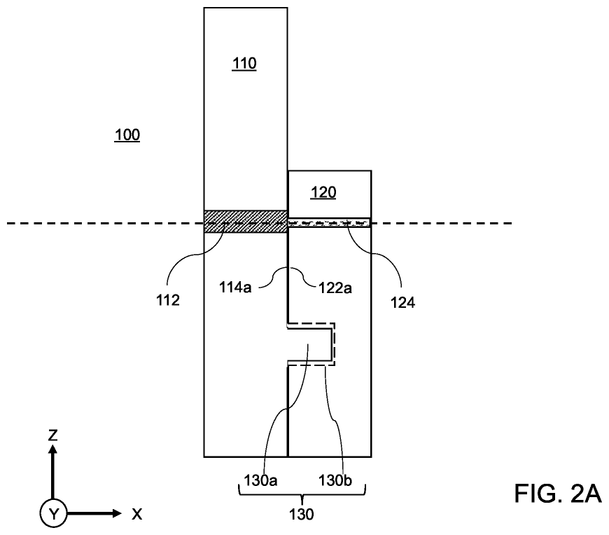

FIG. 1A is an exploded perspective view of an optical device 100 according to one or more embodiments. The optical device 100 may include an optical fiber 110 including a core layer 112, and a cladding layer 114 surrounding the core layer. The core layer 112 is configured to transmit radiation (e.g., visible light, UV radiation and/or IR radiation) along the length (i.e., along the axis) of the optical fiber 110. The optical device 100 may also include a first portion 130a of a fiber alignment structure 130 formed on the cladding layer 114. The optical fiber 110 may include any type of optical fiber. For example, the optical fiber 110 may comprise a glass optical fiber in which the core layer 112 comprises a glass layer, and the cladding layer 114 comprises a different glass layer having a lower refractive index than the core layer 112.

The optical device 100 may also include an optical die 120 connected to the optical fiber 110. The optical die 120 may include a die main body 122 and an optical waveguide 124 located in the die main body 122. The optical device 100 may also include a second portion 130b of the fiber alignment structure 130 formed on the die main body 122 and mated to the first portion 130a of the fiber alignment structure 130 so as to align the core layer 112 of the optical fiber 110 with the optical waveguide 124. The optical die 120 may include any type of optical die (e.g., an optical mode converter, an optical switch containing an optical interferometer, etc.). In particular, the optical die 120 may be an optical die for performing quantum computing operations such as optical processing, optical data transfer, optical storage, etc.

As illustrated in FIG. 1A, the first portion 130a of fiber alignment structure 130 may include an alignment projection that projects from an end face 114a of the cladding layer 114. In one embodiment, the end face 114a may comprise a flat surface which is perpendicular to the axis of the optical fiber 110, and the alignment projection may comprise any protrusion which protrudes out of the flat surface of the end face 114a.

In one embodiment, the alignment projection (130a) may be 3D printed onto the end face 114a of the cladding layer 114 (e.g., an end that has been cleaved by laser or otherwise). In this embodiment, the alignment projection may comprise an optical polymer material that is 3D printed onto the glass end face 114a of the cladding layer 114 using any suitable 3D printing method, such as two-photon polymerization. Alternatively, any other selective or non-selective material deposition process may be used. If a non-selective material deposition process is used, then the deposited material may be patterned to form the alignment projection using photolithography and etching, or another suitable patterning process.

In another embodiment, the alignment projection (130a) may be etched in the end face 114a of the cladding layer 114 by forming a sacrificial etching mask onto the end face 114a and performing an etching process (e.g., wet and/or dry etching process). The sacrificial etching mask may comprise a photoresist material that is patterned by photolithography. The mask covers the location of the alignment projection on the end face 114a and exposes the rest of the end face 114a and the end of the core layer 112. The exposed portion of the end face 114a and the core layer 112 are then etched to form the alignment projection which protrudes from the end face 114a of the cladding layer 114 (i.e., which protrudes from the end face of the optical fiber 110). The mask is then removed by any suitable method, such as ashing or selective etching. In this embodiment, the alignment projection (130a) comprises the same material (e.g., glass) as the cladding layer 114.

The forming of the alignment projection (130a) (whether by 3D printing or etching) can be very accurately aligned not only to a position of the core layer 112 in the optical fiber 110, but also to a PM axis of the optical fiber 110.

The second portion 130b of the fiber alignment structure 130 may include an alignment hole in an end face 122a of the die main body 122. The alignment hole (130b) may be etched in the end face 122a of the die main body 122 by forming a sacrificial etching mask onto the end face 122a and performing an etching process (e.g., wet and/or etching process). The alignment projection (130a) may be inserted into the alignment hole (130b) in order to align the core layer 112 in the optical fiber 110 with the optical waveguide 124 in the optical die 120.

The alignment projection (130a) may include a size and shape corresponding to a size and shape of the alignment hole (130b). For example, in FIG. 1A, the alignment projection (130a) and alignment hole (130b) both have a rectangular cuboid shape. However, the size and shape of the alignment projection (130a) and the alignment hole (130b) in FIG. 1A is merely exemplary and should not be considered limiting in any respect. Further, it is not necessary that the size and shape of the alignment projection (130a) correspond to the size and shape of the alignment hole (130b). That is, the core layer 112 may be aligned with optical waveguide 124 by including an alignment projection (130a) having a size and shape that does not correspond to (or only partly corresponds to) the size and shape of the alignment hole (130b).

A length, width, and height of the alignment hole (130b) may be slightly greater than a length, width, and height of the alignment projection (130a), respectively, to allow the alignment projection (130a) to be inserted into the alignment hole (130b). In particular, the length (in the insertion direction) of the alignment hole (130b) may be slightly greater than a length of the alignment projection (130a), so that that the end face 114a of the cladding layer 114 may abut against the end face 122a of the die main body 122.

The end face 114a of the cladding layer 114 may include a first planar surface and the end face 122a of the die main body 122 may include a second planar surface that is substantially parallel to the first planar surface. An optional adhesive layer 140 may be formed between the optical fiber 110 and the optical die 120 and may fix the optical fiber 110 to the optical die 120. The adhesive layer 140 may be formed between and bond the end face 114a of the cladding layer 114 and the end face 122a of the die main body 122. The adhesive layer 140 may include, for example, an epoxy, solder, glass seal, silicone-based optically clear adhesive, etc.

FIG. 1B is an exploded perspective view of an optical device 150 according to one or more alternative embodiments. The optical device 150 may have a design that is substantially the same as the optical device 100, except that instead of having the fiber alignment structure 130, the optical device 150 may include a fiber alignment structure 130′. The fiber alignment structure 130′ may include a first portion 130a′ that includes an alignment hole on an end face 114a of the cladding layer 114. The fiber alignment structure 130′ may also include a second portion 130b′ that includes an alignment projection that projects from an end face 122a of the die main body 122. As in the optical device 100, in the optical device 150, the alignment projection may be inserted into the alignment hole in order to align the core layer 112 in the optical fiber 110 with the optical waveguide 124 in the optical die 120.

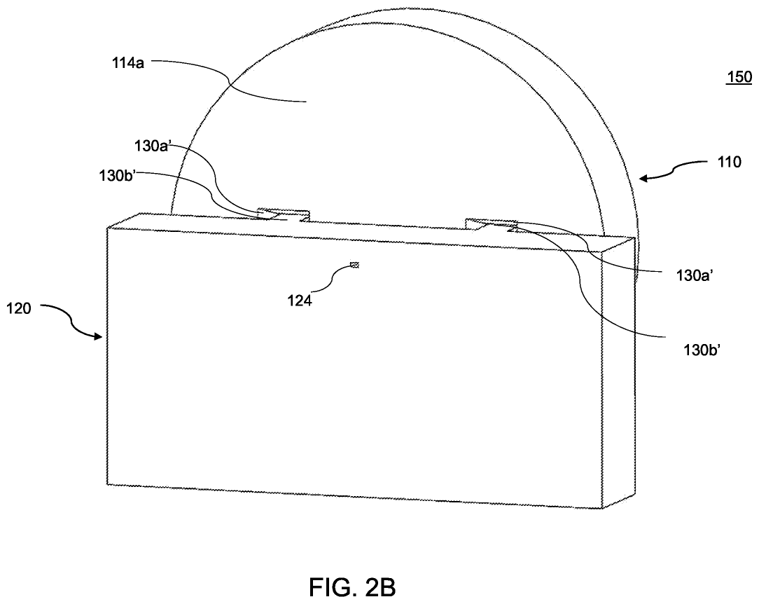

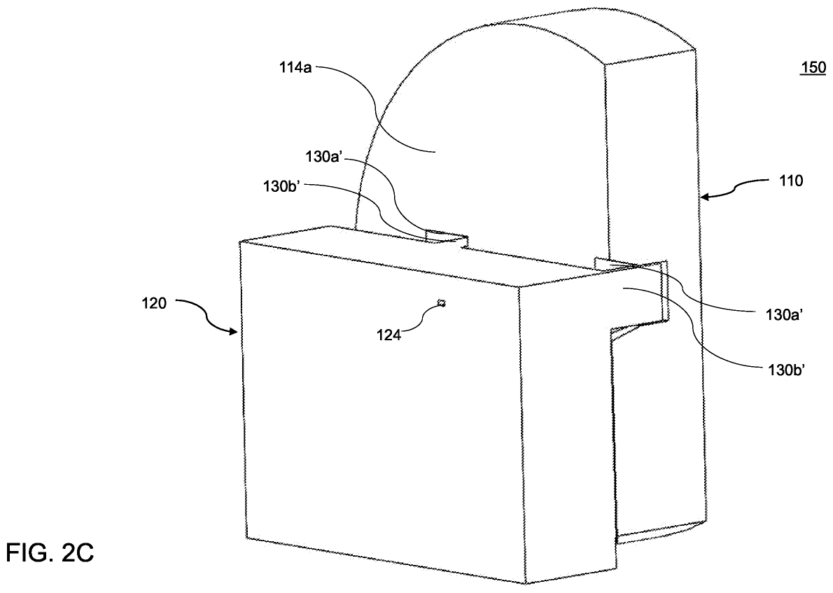

FIG. 2A is a vertical cross-sectional view of the optical device 100 according to one or more embodiments. As illustrated in FIG. 2A, the alignment projection (130a) on the end face 114a of the cladding layer 114 (e.g., first portion 130a of the fiber alignment structure 130) may be inserted into the alignment hole (130b) on the end face 122a of the die main body 122 (e.g., second portion 130b of the fiber alignment structure 130). A length (in the x-direction), width (in the y-direction), and height (in the z-direction) of the alignment hole (130b) may be slightly greater than a length, width, and height of the alignment projection (130a), respectively, to allow the alignment projection (130a) to be inserted into the alignment hole (130b).

A terminal part of the core layer 112 may be coplanar with (e.g., flush with) the end face 114a of the cladding layer 114. A terminal part of the optical waveguide 124 may be coplanar with (e.g., flush with) the end face 122a of the die main body 122. Thus, as the end face 114a of the cladding layer 114 may contact (e.g., abut) the end face 122a of the die main body 122, an end face of the core layer 112 in the optical fiber 110 may contact (e.g., abut) an end face of the optical waveguide 124 in the optical die 120. An alignment of the core layer 112 in the optical fiber 110 with the optical waveguide 124 in the optical die 120 may consist of, for example, substantially aligning (in the y and z direction in FIG. 2A) a central region of the end face of the core layer 112 with a central region of the end face of the optical waveguide 124.

In addition, the dashed line in FIG. 2A depicts an axis of the core layer 112 in the optical fiber 110 and an axis of the optical waveguide 124 in the optical die 120. That is, the axis of the core layer 112 in the optical fiber 110 may be substantially colinear with the axis of the optical waveguide 124 in the optical die 120 by using the alignment structure 130 to align the wider (e.g., larger diameter) core layer 112 to the narrower (e.g., smaller diameter) waveguide 124.

In another alternative embodiment, the fiber alignment structure may include plural alignment projections and/or alignment holes on each of the end face 114a and the end face 112a. For example, the end face 114a may include two or more alignment projections, while the end face 122a may include two or more corresponding alignment holes. Alternatively, the end face 114a may include one or more alignment projections and one or more alignment holes, and the end face 122a may include one or more corresponding alignment holes and one or more alignment projections.

In another embodiment shown in FIGS. 2B and 2C, the end face 114a of the cladding layer 114 of the optical device 150 may include two or more alignment holes (130a′), while the end face 122a of the optical die may include two or more corresponding alignment projections (130b′). The alignment projections and/or the alignment holes may include beveled edges (e.g., chamfered edges) that may help to facilitate insertion of the alignment projections (130a) into the alignment holes (130b).

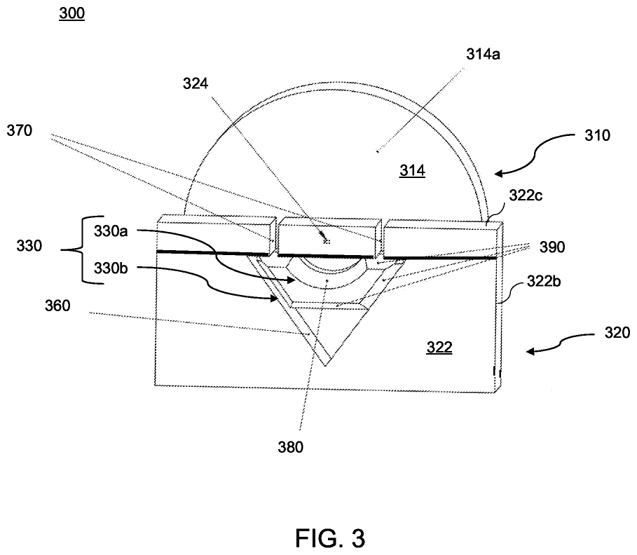

FIG. 3 is a perspective view of an optical device 300 according to one or more embodiments. The optical device 300 may include an optical fiber 310 including a core layer (not shown), and a cladding layer 314 formed on the core layer. The optical device 300 may also include an alignment projection serving as a first portion 330a of a fiber alignment structure 330 formed on the cladding layer 314. The optical fiber 310 may include any type of optical fiber.

The optical device 300 may also include an optical die 320 connected to the optical fiber 310 (e.g., bonded to the optical fiber 310 by an adhesive) and including a die main body 322. The die main body 322 may include a silicon layer (e.g., silicon portion) 322b and a glass layer (e.g., glass portion) 322c located on the silicon layer 322b. An optical waveguide 324 may be formed in the glass layer 322c. An alignment hole serving as a second portion 330b of the fiber alignment structure 330 may be formed on the die main body 322 and mated to the alignment projection (330a) so as to align the core layer of the optical fiber 310 with the optical waveguide 324.

As illustrated in FIG. 3, the alignment hole (330b) may be formed in the silicon layer 322b of the die main body 322. Alternatively, the alignment hole (330b) may be formed in the glass layer 322c of the die main body 322. The optical die 320 may include any type of optical die. In particular, the optical die 320 may be an optical die for performing quantum computing operations such as optical processing, optical data transfer, optical storage, etc.

The alignment projection may be 3D printed (e.g., using two-photon polymerization) onto the end face 314a of the cladding layer 314. Alternatively, the alignment projection (330a) may be etched in the end face 314a of the cladding layer 314 by forming a sacrificial etching mask onto the end face 314a and performing an etching process (e.g., wet and/or dry etching process). The forming of the alignment projection (330a) can be very accurately aligned not only to a position of the core layer in the optical fiber 310, but also to a PM axis of the optical fiber 310.

The alignment hole (330b) may be formed, for example, by crystallographic wet etching on an end face (not shown) of the die main body 322 that faces the end face 314a of the cladding layer 314 of the optical fiber 310. The end face of the die main body 322 may be mated to and abut the end face 314a of the cladding layer 314. An adhesive layer (not shown) may be used to bond the end face 314a of the cladding layer 314 and the end face of the die main body 322. The adhesive layer may include, for example, an epoxy, solder, glass seal, silicone-based optically clear adhesive, etc.

An undercut area 360 may be included in the die main body 322 and may be merged with the alignment hole (330b). The undercut area 360 may provide a reference feature that may be relied on as a point of reference in performing an alignment of the optical fiber 310 to the optical die 320. This undercut area can be formed in many ways including, for example, a crystallographic wet etch process or a deep reacting ion etch (DRIE) process, etc.

One or more holes 370 (e.g., slits) may also be formed in the die main body 322 and used to create the undercut area 360. For example, the holes 370 may be etched in the glass layer 322c through a sacrificial etching mask, followed by providing the wet etching medium through the holes 370 to the silicon layer 322b to perform the crystallographic wet etching on the silicon layer 322b to form the alignment hole (330b) and the undercut area 360 in the silicon layer 360. In this embodiment, the alignment hole (330b) is much larger than the alignment projection (330a) due to the presence of the undercut region 360 in the alignment hole.

The alignment projection (330a) may include a recessed area 380 (e.g., semi-circular recess) that may be formed adjacent to the core layer of the optical fiber 310. The recessed area 380 may help to ensure that the alignment projection (330a) clears the optical beam that may be transmitted by the core layer of the optical fiber 310.

The alignment projection (330a) may also include one or more a beveled edges 390 (e.g., a coning or drafting feature) that may help to facilitate insertion of the alignment projection (330a) into the alignment hole (330b). 3D printing of the alignment projection (330a) may be achieved relative to the core layer of the optical fiber 310, eliminating core positional errors and fiber diameter tolerances from the passive alignment. Thus, the beveled edges 390 may be formed (e.g., corners can be trimmed) on the alignment projection (330a) to eliminate sticking without affecting alignment accuracy.

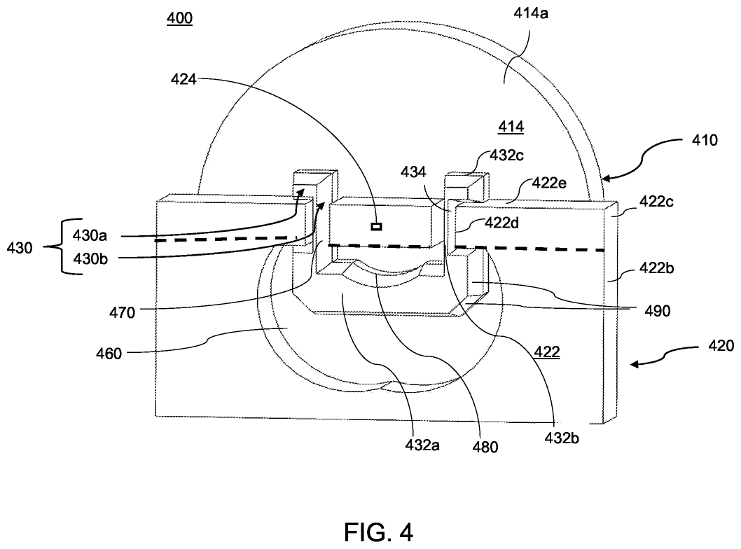

FIG. 4 is a perspective view of an optical device 400 according to one or more embodiments. The optical device 400 may include an optical fiber 410 including a core layer (not shown), and a cladding layer 414 formed on the core layer. The optical device 400 may also include an alignment projection serving as a first portion 430a of a fiber alignment structure 430 formed on the cladding layer 414. The alignment projection may have a U-shape or cross structure that may provide mechanical strength to the alignment projection (430a). The alignment projection (430a) may alternatively be inverted (e.g., an inverted U-shaped projection or cross structure) from that illustrated in FIG. 4.

The optical device 400 may also include an optical die 420 connected to the optical fiber 410 and including a die main body 422. The die main body 422 may include a silicon layer 422b and a glass layer 422c located on the silicon layer 422b. An optical waveguide 424 may be formed in the glass layer 422c. An alignment hole serving as a second portion 430b of the fiber alignment structure 430 may be formed on the die main body 422 by dry etching (DRIE). The alignment projection (430a) may be mated to a wall 422d of the die main body 422 (e.g., an outer wall of the alignment hole (430b) formed in the glass layer 422c) so as to align the core layer of the optical fiber 410 with the optical waveguide 424.

As illustrated in FIG. 4, the alignment hole (430b) may be formed in the glass layer 422c of the die main body 422. Alternatively, the alignment hole (430b) may be formed in the silicon layer 422b of the die main body 422. The optical die 420 may include any type of optical die. In particular, the optical die 420 may be an optical die for performing quantum computing operations such as optical processing, optical data transfer, optical storage, etc.

The alignment projection (430a) may be 3D printed (e.g., using two-photon polymerization) onto the end face 414a of the cladding layer 414. Alternatively, the alignment projection (430a) may be etched in the end face 414a of the cladding layer 414 by an etching process (e.g., wet or dry etching process).

The alignment hole (430b) may be formed on an end face (not shown) of the die main body 422 that faces the end face 414a of the cladding layer 414 of the optical fiber 410. The end face of the die main body 422 may be mated to and abut the end face 414a of the cladding layer 414. An adhesive layer (not shown) may be used to bond the end face 414a of the cladding layer 414 and the end face of the die main body 422.

An undercut area 460 may be included in the die main body 422 and may be merged with the alignment hole (430b). The alignment projection (430a) may have similar function as the alignment projection (330a) in the optical device 300 (e.g., where the alignment hole (330b) may be formed by wet etching), but may register to an outer portion of the undercut area 460 instead.

One or more holes 470 (e.g., slits) may also be formed in the glass layer 422c of the die main body 422 and used to provide access for the etching medium to the silicon layer 422b to create the undercut area 460 in the silicon layer 422b. In this embodiment, the holes 470 correspond to the alignment holes 430b.

The U-shaped alignment projection (430a) may include a cross bar portion 432a and two strut portions 432b which have first ends connected to the ends of the cross bar portion 432a, and two wing portions 432c connected to second ends of the respective strut portions 432b. The strut portions 432b extend perpendicular to the cross bar portion 432a. The wing portions 432c extend away from each other parallel to the cross bar portion 432a and perpendicular to the strut portions 432b. The bottoms of the wing portions 432c may rest on the outer top surfaces 422e of the die main body 422 (e.g., on the outer top surfaces of the glass layer 422c located outside the holes 470). The strut portions 432b may be inserted into the holes 470 (i.e., alignment holes 430b) to provide alignment between the core layer and the optical waveguide 424. The outer portions of the glass layer 422c may be inserted into lateral recesses 434 in the outer sidewalls of the strut portions 432b to provide additional alignment.

The alignment projection (430a) may include a recessed area 480 (e.g., semi-circular recession or relief) that may be formed adjacent to the core layer. The alignment projection (430a) may also include one or more a beveled edges 490 (e.g., a coning or drafting feature) that may help to facilitate insertion of the alignment projection (430a) into the alignment hole (430b).

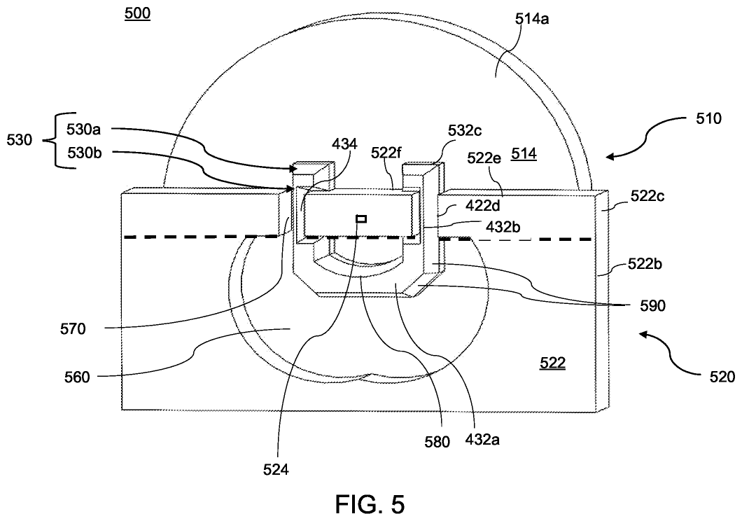

FIG. 5 is a perspective view of an optical device 500 according to one or more embodiments. The optical device 500 may include an optical fiber 510 including a core layer (not shown), and a cladding layer 514 formed on the core layer. The optical device 500 may also include an alignment projection serving as a first portion 530a of a fiber alignment structure 530 formed on the cladding layer 514. The alignment projection (530a) may have a U-shape or cross structure that may provide mechanical strength to the alignment projection (530a). The alignment projection (530a) may alternatively be inverted (e.g., an inverted U-shaped projection or cross structure) from that illustrated in FIG. 5.

The optical device 500 may also include an optical die 520 connected to the optical fiber 510 and including a die main body 522. The die main body 522 may include a silicon layer 522b and a glass layer 522c located on the silicon layer 522b. An optical waveguide 524 may be formed in the glass layer 522c. An alignment hole serving as a second portion 530b of the fiber alignment structure 530 may be formed on the die main body 522 by dry etching (DRIE). The alignment projection (530a) may be mated to a wall 522d of the die main body 522 so as to align the core layer of the optical fiber 510 with the optical waveguide 524.

The U-shaped alignment projection (530a) may include a cross bar portion 532a and two strut portions 532b which have first ends connected to the ends of the cross bar portion 532a, and two wing portions 532c connected to second ends of the respective strut portions 532b. The strut portions 532b extend perpendicular to the cross bar portion 532a. In the embodiment of FIG. 5, the wing portions 532c extend toward each other (rather than away from each other as the optical device 400 of FIG. 4) parallel to the cross bar portion 532a and perpendicular to the strut portions 532b. The bottoms of the wing portions 532c may rest on the inner top surfaces 522f of the die main body 522 (e.g., on the inner top surface of the glass layer 522c located between the holes 570 rather than on the outer top surfaces 522e). The strut portions 532b may be inserted into the holes 570 (i.e., alignment holes 530b) to provide alignment between the core layer and the optical waveguide 524. The inner portion of the glass layer 522c located between two holes 570 may be inserted into lateral recesses 534 in the inner sidewalls of the strut portions 532b to provide additional alignment.

As illustrated in FIG. 5, the alignment hole (530b) may be formed in the glass layer 522c of the die main body 522. Alternatively, the alignment hole (530b) may be formed in the silicon layer 522b of the die main body 522. The optical die 520 may include any type of optical die. In particular, the optical die 520 may be an optical die for performing quantum computing operations such as optical processing, optical data transfer, optical storage, etc.

The alignment projection (530a) may be 3D printed (e.g., using two-photon polymerization) onto the end face 514a of the cladding layer 514. Alternatively, the alignment projection (530a) may be etched in the end face 514a of the cladding layer 514 by an etching process (e.g., wet or dry etching process).

The alignment hole (530b) may be formed on an end face (not shown) of the die main body 522 that faces the end face 514a of the cladding layer 514 of the optical fiber 510. The end face of the die main body 522 may be mated to and abut the end face 514a of the cladding layer 514. An adhesive layer (not shown) may be used to bond the end face 514a of the cladding layer 514 and the end face of the die main body 522.

An undercut area 560 may be included in the die main body 522 and may join, for example, the alignment hole (530b). The alignment projection (530a) may have similar function as the alignment projection (530a) in the optical device 300 (e.g., where the alignment hole (330b) may be formed by wet etching), but may register to an inner portion of the undercut area 560 instead. One or more holes 570 (e.g., slits) may also be formed in the die main body 522 and used to create the undercut area 560.

The alignment projection (530a) may include a recessed area 580 (e.g., circular recession or relief) that may be formed adjacent to the core layer. The alignment projection (530a) may also include one or more a beveled edges 590 (e.g., a coning or drafting feature) that may help to facilitate insertion of the alignment projection (530a) into the alignment hole (530b).

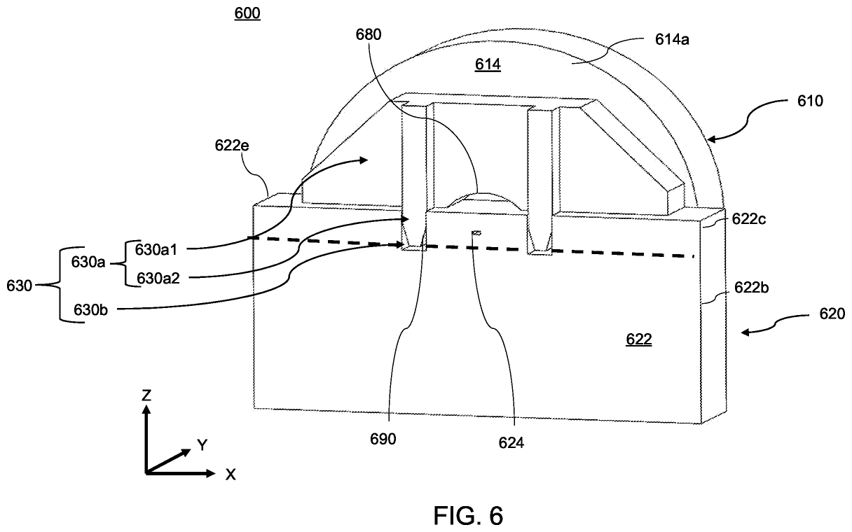

FIG. 6 is a perspective view of an optical device 600 according to one or more embodiments. The optical device 600 may include an optical fiber 610 including a core layer (not shown), and a cladding layer 614 formed on the core layer. The optical device 600 may also include a first portion 630a of a fiber alignment structure 630 formed on the cladding layer 614. The first portion 630a may include a bracket portion 630al that projects from the end face 614a of the cladding layer 614 and may be pressed flat against (e.g., mounted on) a top surface 622e of the die main body 622 (e.g., the top surface of the glass layer 622c). The first portion 630a may also include one or more alignment projections 630a2 (e.g., locating pins or wedges) that project from the bracket portion 630al outward in the y-direction and downward in the z-direction in FIG. 6.

The optical device 600 may also include an optical die 620 connected to the optical fiber 610 and including a die main body 622. Unlike in the optical devices 300, 400 and 500, in the optical device 600, the optical fiber 610 may be mated to the optical die 620 without an undercut feature in the die main body 622. The die main body 622 may include a silicon layer 622b and a glass layer 622c located on the silicon layer 622b. An optical waveguide 624 may be formed in the glass layer 622c.

One or more alignment holes serving as a second portion 630b of the fiber alignment structure 630 may be formed on the die main body 622 by wet etching or by dry etching (e.g., DRIE). In particular, the alignment holes (630b) may be formed in the upper surface 622e of the die main body 622 (e.g., of the glass layer 622c). The alignment projections 630a2 (e.g., locating pins or wedges) that project from the bracket portion 630al may be inserted into the alignment holes (630b) which may help to obtain precise alignment in the transverse direction (e.g., the x-direction in FIG. 6). Further, the bracket portion 630al contacting the upper surface 622e of the die main body 622 may help to obtain precise alignment in the z-direction. The fiber alignment structure 630 may thereby precisely align the core layer of the optical fiber 610 with the optical waveguide 624.

As illustrated in FIG. 6, the alignment holes (630b) may be formed in the glass layer 622c of the die main body 622. Alternatively, the alignment holes (630b) may be formed in the silicon layer 622b of the die main body 622. The optical die 620 may include any type of optical die. In particular, the optical die 620 may be an optical die for performing quantum computing operations such as optical processing, optical data transfer, optical storage, etc.

The first portion 630a of the fiber alignment structure 630 (e.g., the bracket portion 630al and the alignment projections 630a2) may be 3D printed (e.g., using two-photon polymerization) onto the end face 614a of the cladding layer 614. Alternatively, the first portion 630a of the fiber alignment structure 630 may be etched in the end face 614a of the cladding layer 614 by an etching process (e.g., wet etching process).

The alignment holes (630b) may be formed by etching the upper surface 622e of the die main body 622. The end face of the die main body 622 may be mated to and abut the end face 614a of the cladding layer 614. An adhesive layer (not shown) may be used to bond the end face 614a of the cladding layer 614 and the end face of the die main body 622. If an adhesive (e.g., epoxy) is used in the assembly of the optical device 600, then the design also accounts for a thickness of the adhesive.

The bracket portion 630al may include a recessed area 680 (e.g., semi-circular recession or relief) that may be formed adjacent to the core layer. The alignment projections may also include one or more a beveled edges 690 (e.g., a coning or drafting feature) that may help to facilitate insertion of the alignment projections 630a2 into the alignment holes (630b).

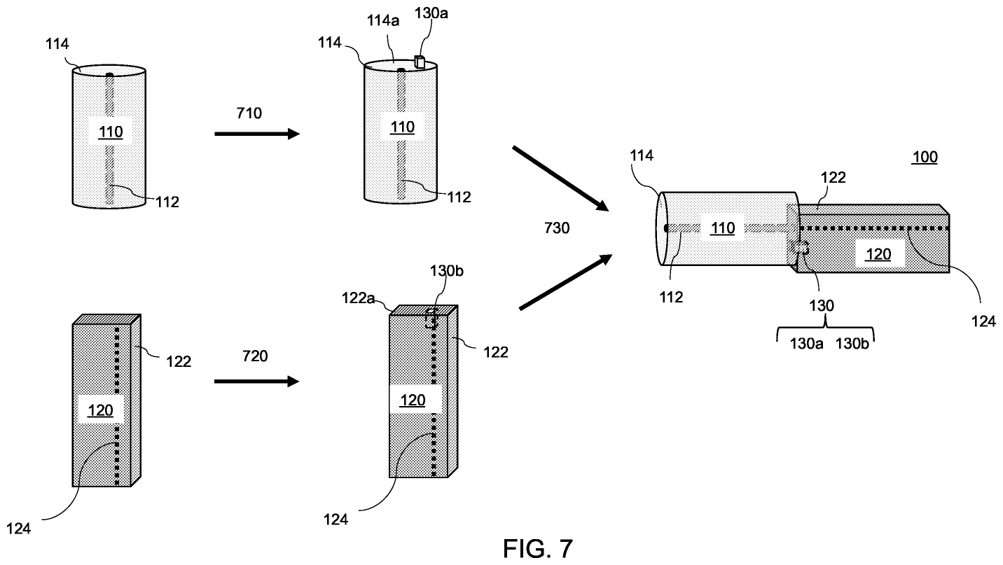

FIG. 7 illustrates a method of making the optical device 100 according to one or more embodiments. In the method of FIG. 7, the optical fiber 110 including the core layer 112 and the cladding layer 114 and the optical die 120 including the die main body 122 and the optical waveguide 124 in the die main body 122 are provided separately.

In a Step 710, the first portion 130a (e.g., alignment projection) of the fiber alignment structure 130 may be formed on the end face 114a of the cladding layer 114. The alignment projection 130a may be 3D printed (e.g., using two-photon polymerization) onto the end face 114a of the cladding layer 114. Alternatively, the alignment projection (130a) may be etched in the end face 114a of the cladding layer 114 by forming a mask onto the end face 114a and performing an etching process (e.g., wet or dry etching process).

In Step 720, the second portion 130b (e.g., alignment hole) of the fiber alignment structure 130 may be formed on the end face 122a of the die main body 122. The alignment hole (130b) may be etched in the end face 122a of the die main body 122 by forming a mask onto the end face 122a and performing an etching process (e.g., crystallographic wet etching process). Alternatively, the alignment hole (130b) may be etched in the end face 122a of the die main body 122 by a dry etching process (e.g., DRIE).

In Step 730, the optical fiber 110 and the optical die 120 are assembled together to form the optical device 100. In particular, in Step 730 the end face 114a of the cladding layer 114 may be mated to the end face 122a of the die main body 122. The alignment projection (130a) may be inserted into the alignment hole (130b), thereby aligning the core layer 112 of the optical fiber 110 to be aligned with the optical waveguide 124 in the optical die 120. An adhesive layer may be applied between the end face 114a of the cladding layer 114 and the end face 122a of the die main body 122 so as to bond the optical fiber 110 to the optical die 120. The adhesive layer may include, for example, an epoxy, solder, glass seal, silicone-based optically clear adhesive, etc.

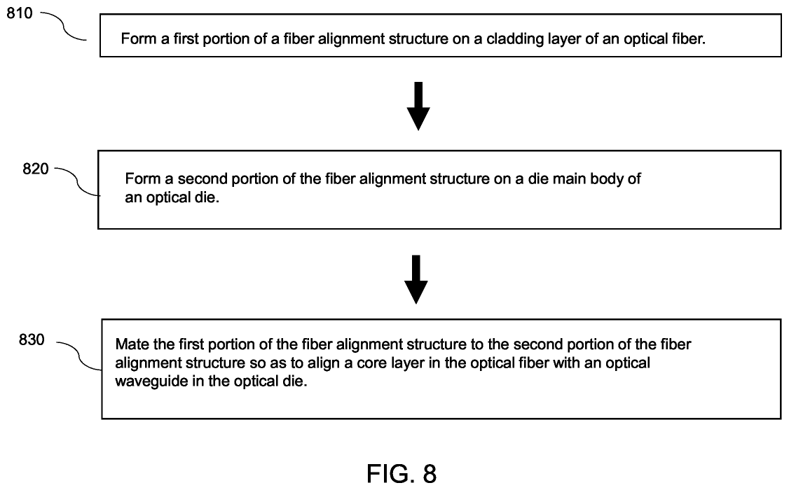

FIG. 8 illustrates a flow chart of a method of forming an optical device, such as the method of forming the optical device 100 described above with respect to FIG. 7, according to one or more embodiments. The method may include a Step 810 of forming a first portion of a fiber alignment structure on a cladding layer of an optical fiber, a Step 820 of forming a second portion of the fiber alignment structure on a die main body of an optical die, and a Step 830 of mating the first portion of the fiber alignment structure to the second portion of the fiber alignment structure so as to align a core layer in the optical fiber with an optical waveguide in the optical die.

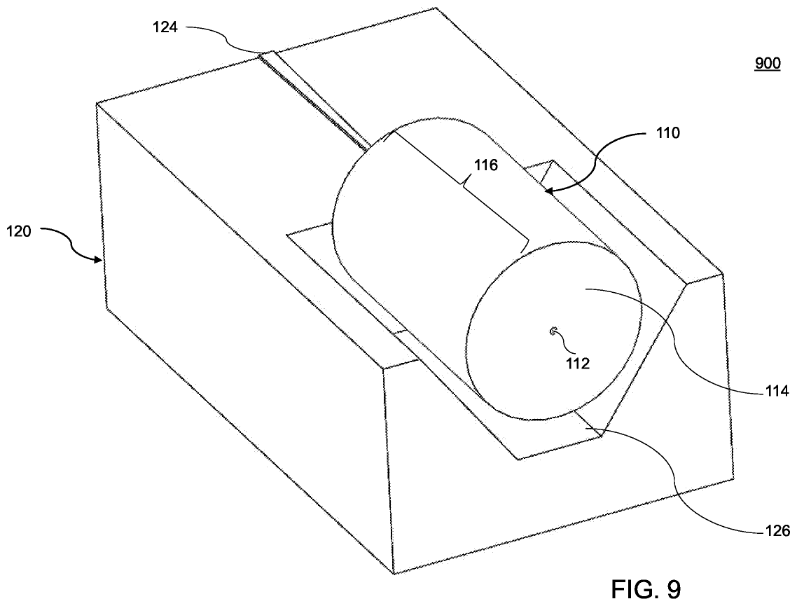

FIG. 9 illustrates a back side view of an optical device 900 according to an alternative embodiment in which the optical fiber is located in a groove in the optical die, in contrast to FIGS. 1A-7 which illustrate butted connections between the optical fiber (e.g., 110) and the optical die (e.g., 120). The optical device 900 may have any suitable fiber alignment structure described above, such as the fiber alignment structure 130 of the optical device 100 shown in FIGS. 1A and 2A. The fiber alignment structure is not shown in the back view of FIG. 9 because it is located behind the optical fiber 110. Thus, instead of the butted connection between the optical fiber 110 and the optical die 120 shown in FIGS. 2A and 7, the terminal portion 116 of the optical fiber 110 of the optical device 900 of FIG. 9 is located in a groove 126 in the optical die 120. The groove 126 may be a V-shaped groove, a U-shaped groove or any other shaped groove. The groove 126 may have a width much larger than the diameter of the optical fiber 110 to allow movement of the optical fiber 110 in the groove 126 to mate the second portion of the fiber alignment structure formed on the die main body to be mated to the first portion of the fiber alignment structure formed on the optical fiber so as to align the core layer 112 of the optical fiber 110 with the optical waveguide 124 of the optical die 120.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

It is also understood that the examples and embodiments described herein are for illustrative purposes only and that various modifications or changes in light thereof will be suggested to persons skilled in the art and are to be included within the spirit and purview of this application and scope of the appended claims.

It will be understood that, although the terms first, second, etc. are, in some instances, used herein to describe various elements, these elements should not be limited by these terms. These terms are used only to distinguish one element from another. The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “if” is, optionally, construed to mean “when” or “upon” or “in response to determining” or “in response to detecting” or “in accordance with a determination that,” depending on the context.

What is claimed is:

1. An optical device, comprising:
an optical fiber comprising:
a core layer;
a cladding layer formed on the core layer; and
a first portion of a fiber alignment structure formed on an end face of the cladding layer; and
an optical die connected to the optical fiber, comprising:
a die main body;
an optical waveguide located in the die main body; and
a second portion of the fiber alignment structure formed on the die main body and mated to the first portion of the fiber alignment structure so as to align the core layer of the optical fiber with the optical waveguide.

2. The optical device of claim 1, wherein the second portion of the fiber alignment structure comprises an alignment hole on an end face of the die main body, and the first portion of the fiber alignment structure comprises an alignment projection that projects from the end face of the cladding layer and is inserted into the alignment hole.

3. The optical device of claim 2, wherein the end face of the cladding layer comprises a first planar surface and the end face of the die main body comprises a second planar surface that is substantially parallel to the first planar surface.

4. The optical device of claim 2, wherein the alignment projection comprises a recessed area adjacent to the core layer.

5. The optical device of claim 2, wherein the alignment projection comprises a size and shape corresponding to a size and shape of the alignment hole.

6. The optical device of claim 2, wherein the alignment hole comprises an undercut region that serves as a reference structure for mating the alignment projection to the alignment hole.

7. The optical device of claim 2, wherein the die main body comprises:
a silicon layer; and
a glass layer located on the silicon layer and including the optical waveguide.

8. The optical device of claim 7, wherein the alignment hole is formed in the silicon layer of the die main body.

9. The optical device of claim 7, wherein the alignment hole is formed in the glass layer of the die main body.

10. The optical device of claim 9, wherein the alignment hole comprises a plurality of alignment holes formed in the glass layer on opposing sides of the optical waveguide.

11. The optical device of claim 1, wherein the first portion of the fiber alignment structure comprises an alignment hole on an end face of the cladding layer, and the second portion of the fiber alignment structure comprises an alignment projection that projects from an end face of the die main body and is inserted into the alignment hole.

12. The optical device of claim 1, further comprising an adhesive layer formed between the optical fiber and the optical die and fixing the optical fiber to the optical die.

13. A method of forming an optical device, comprising:
forming a first portion of a fiber alignment structure on an end face of a cladding layer of an optical fiber;
forming a second portion of the fiber alignment structure on a die main body of an optical die; and
mating the first portion of the fiber alignment structure to the second portion of the fiber alignment structure so as to align a core layer in the optical fiber with an optical waveguide in the optical die.

14. The method of claim 13, wherein:
the second portion of the fiber alignment structure comprises an alignment hole on the end face of the die main body, and the first portion of the fiber alignment structure comprises an alignment projection that projects from an end face of the cladding layer, and
the step of mating of the first portion of the fiber alignment structure to the second portion of the fiber alignment structure comprises inserting the alignment projection into the alignment hole.

15. The method of claim 14, wherein:
the end face of the cladding layer comprises a first planar surface and the end face of the die main body comprises a second planar surface; and
the step of mating of the first portion of the fiber alignment structure to the second portion of the fiber alignment structure comprises mating the second planar surface to be substantially parallel to the first planar surface.

16. The method of claim 14, wherein:
the step of forming of the first portion of the fiber alignment structure comprises forming a recessed area in the alignment projection; and
the step of mating of the first portion of the fiber alignment structure to the second portion of the fiber alignment structure comprises locating the recessed area adjacent to the core layer.

17. The method of claim 14, wherein:
the alignment hole comprises an undercut region; and
the step of mating of the first portion of the fiber alignment structure to the second portion of the fiber alignment structure comprises using the undercut region as a reference structure.

18. The method of claim 14, wherein the first portion of the fiber alignment structure is formed by 3D printing on the end face of the cladding layer.

19. The method of claim 13, wherein:
the first portion of the fiber alignment structure comprises an alignment hole on an end face of the cladding layer, and the second portion of the fiber alignment structure comprises an alignment projection that projects from an end face of the die main body; and
the step of mating of the first portion of the fiber alignment structure to the second portion of the fiber alignment structure comprises inserting the alignment projection into the alignment hole.

20. An optical fiber, comprising:
a core layer;
a cladding layer formed on the core layer; and
a first portion of a fiber alignment structure comprising an alignment projection or an alignment hole formed on an end face of the cladding layer,
wherein the first portion of the fiber alignment structure is configured to be mated to a portion of the fiber alignment structure located on an optical die so as to align the core layer of the optical fiber with an optical waveguide of the optical die.

21. The optical fiber of claim 20, wherein the first portion of the fiber alignment structure comprises the alignment projection that projects from the end face of the cladding layer and is configured to be inserted into the second portion of the fiber alignment structure which comprises an alignment hole.
